(19) United States
(12) Patent Application Publication
(10) Pub. No.: US 2009/0284445 A1
(43) Pub. Date: Nov. 19, 2009

(54) LED DATA INPUT SCHEME WITH SEQUENTIAL SCAN METHOD AND CASCADE CONNECTION FOR LIGHT EMITTING DIODE (LED) DISPLAY SYSTEM

(76) Inventors: Sheng-Chang Kuo, Jhubei City (TW); Hsin-Chiang Huang, Jhubei City (TW)

Correspondence Address: SINORICA, LLC, 2275 Research Blvd., Suite 500, ROCKVILLE, MD, 20850, US

(21) Appl. No.: 12/120,755

(22) Filed: May 15, 2008

(51) Int. Cl. G09G 3/14; G09G 3/32

(52) U.S. Cl. 345/46; 345/82; 315/169.2

(57) ABSTRACT

This invention is an architecture of Driver IC used by the LED light systems. Each Driver IC comprises at least one Drive Cell that connects to an individual LED. The LED data are transmitted via a sequential scanning method from Drive Cell to Drive Cell, and from Driver IC to Driver IC that are connected in a cascade manner.

### FIELD OF INVENTION

This invention relates to an architecture for data and control signals input to a Light Emitting Diode (LED) system.

### BACKGROUND OF THE INVENTION

It is well known to one skilled in the art that the industry has been implementing an architecture that inputs and drives data and control signals by a clocking mechanism for a LED system. The current invention fundamentally changes the traditional mechanism and implements sequential scanning method and cascade connections for control and data signals input.

### SUMMARY OF THE INVENTION

The current invention includes an architecture of a LED system comprises of a Controller, LED Driver Integrated Circuits (ICs), and LEDs. The Controller controls generations of control signals and LED data signals. The LED Driver ICs control the electric current flow through LEDs. The LEDs are the lighting bodies showing color lights with luminance.

The control signals include scan signals and clock signals. The scan signals control data fetching by each LED Driver Cell from the data bus within the Driver IC. The clock signals provides the timing clock to drive the data signals input.

The control signals and data signals are first transmitted to the first Driver IC that is directly connected to a Host Controller of the LED system. Thereafter, the control signals and data signals are transmitted to the second Driver IC that is directly connected to the first Driver IC. Each Driver IC comprises a plurality of LED Drive Cells and each Driver Cell is connected to either an individual LED or a LED module. Because all Driver ICs (including its LED drive Cells) are sequentially connected, the control signals and data signals are sequentially transmitted through each Driver IC (and each LED Drive Cell) along the transmission path until it reaches the designated Driver IC.

### BRIEF DESCRIPTION OF THE DRAWINGS

FIG. 1 is a general LED system architecture and connections.

FIG. 2 is a general architecture of DLDU.

FIG. 3 is an architecture of Driver IC

FIG. 4 shows wave forms of scan, clock, and data signals

FIG. 5 is a process of LED Data Input Algorithm

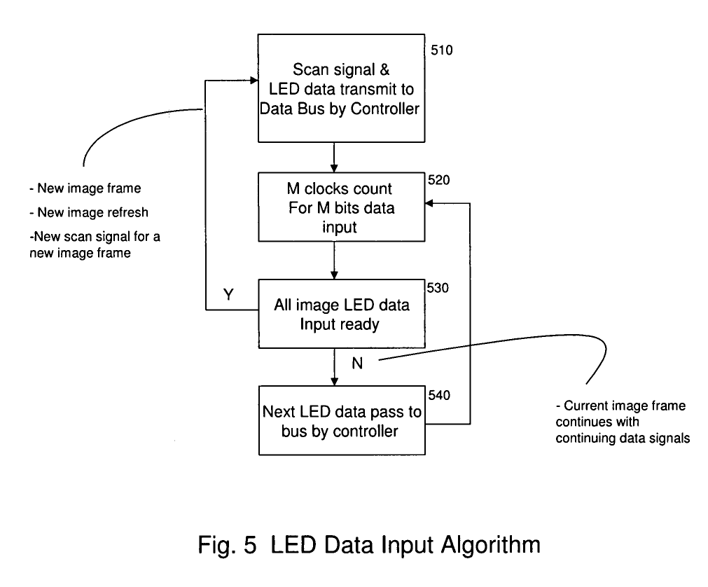

### DETAIL DESCRIPTIONS OF THE INVENTION

Terminology and Lexicography:

First Driver IC: An IC that flows programmed electric current through LED(s) and comprises at least one Drive Cell. The First Driver IC connects to the Controller directly.

Second Driver IC: Other than the First Driver IC, all other ICs (second, third, etc.) are referred as logical sequence per various design requirements of different implementations.

First Drive Cell: The major function of a Drive Cell is controlling the electric current flow and voltage to and from the controlled single LED or LED module. All indexed (first, second, etc.) Drive Cell are referred as logical sequence per various design requirements of different implementations.

LED: A single or an individual LED has two terminals among which one terminal connects to the voltage source and the other terminal connects to the Drive Cell.

LED Module: A plurality of LEDs arranged in connections so that all LEDs are controlled by same controllers. Within the plurality of LEDs, there is only one individual LED connects to the voltage source and only one individual LED connects to the Drive Cell.

Scan Signal: The signal generated by the Controller and driven by Clock inside the Driver IC. It actives dedicated LED Drive Cell to receive data via the Switch.

Enable signal: The signal generated by the Counter per each application design requirements and is transmitted to the Switch for enabling or opening the transmission path.

Sequential Connection/Sequentially connected: Electrical components that are physically connected one after one in sequence so that electric current flow and signals must transmit in sequence through the connections of each component.

The architecture of a LED system includes a Controller, LED Driver ICs, and LEDs. The Controller controls generations of control signals and LED data signals. The LED Driver ICs control the electric current flow through LEDs. The LEDs are the lighting bodies showing color lights with luminance.

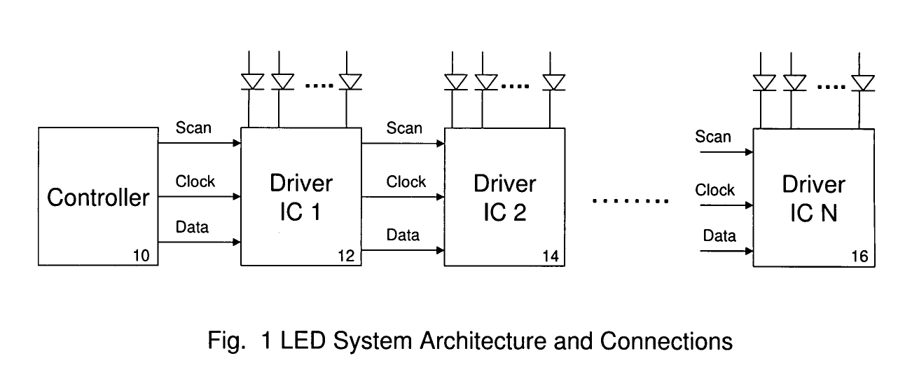

The FIG. 1 shows a general architecture for a LED system that includes a Controller 10, a plurality of Driver IC 12, 14, and 16. The Driver ICs are sequentially connected with the Driver IC 1, 12 being directly connected to the Controller. The scan signals, clock signals, and data signals are sequentially transmitted from Driver IC 1, 12, via Driver IC 2, 14, to the end Driver IC N, 16. The Controller 10 is a micro-processor or a digital processor for calculating and recording the image stream data. The Controller 10 generates control signals and LED data signals and provides the required color saturation or luminance information to the LED Drive Cells with each Driver IC.

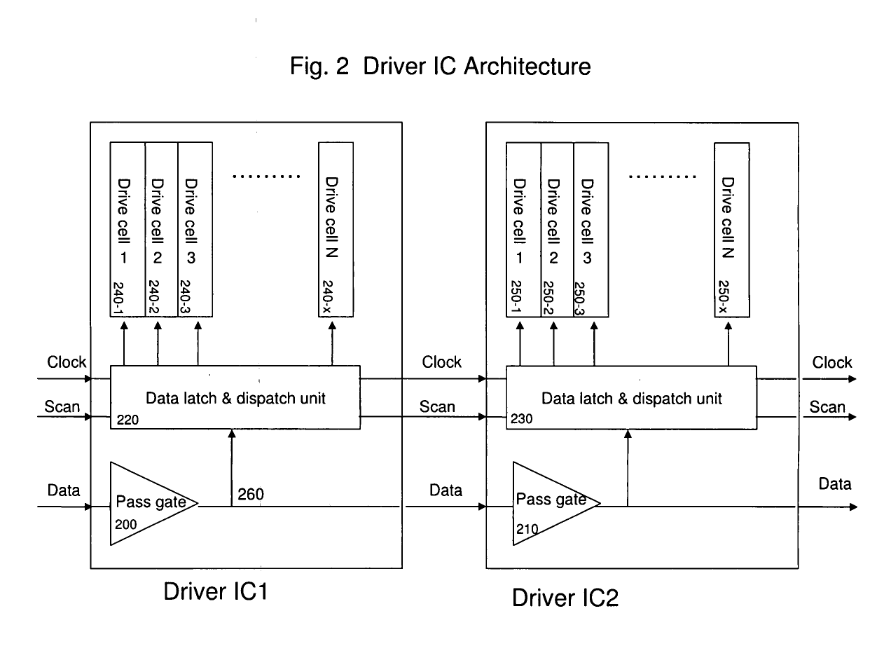

The FIG. 2 shows a general architecture for Driver ICs. Each of the Driver ICs includes a Pass Gate 200, 210, a Data Latch & Dispatch Unit (DLDU) 220, 230, a plurality of Drive Cells 240-1, 240-2, . . . 240-X, 250-1, 250-2, . . . , 250-Y. The Driver IC is a unit that controls basic electric current flow. Each Drive Cell controls a corresponding connected LED or LED module. The DLDU controls the data fetching from the data bus 260 and dispatching the fetched data to a corresponding LED Drive Cell for its dedicated LED. The Pass Gate 200, 210 and the Data Bus 260 are built within each Driver IC for data transmission. The Pass Gate 200, 210 transmits data signals sequentially from Driver IC 1 to the end Driver IC without being driven in accordance with clock signals.

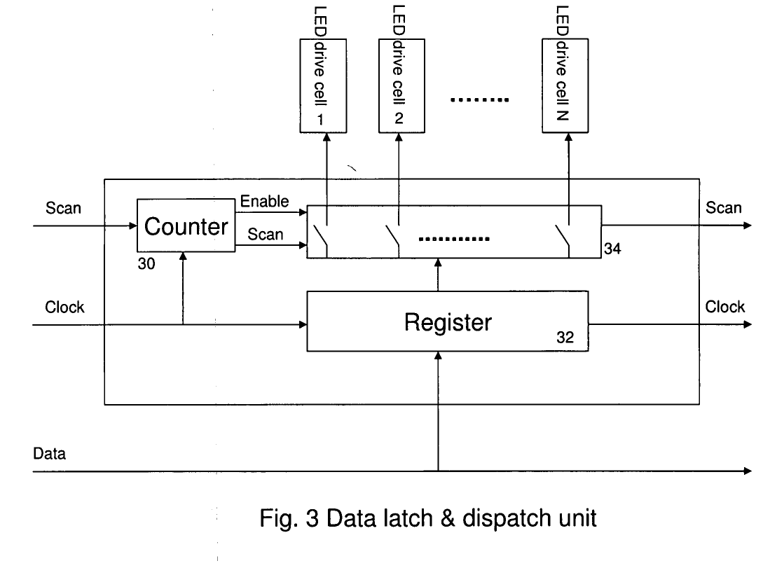

The FIG. 3 shows a general architecture of a DLDU which includes a Counter 30, a Register 32, and a Switch 34. The Counter performs clock counting based on design requirements and generates a Fetching signal and an Enabling signal for transmitting to the Switch. The Register 32 stores temporary data fetched from the Data Bus 260. The Switch 34 sets up and establishes a transmission path to a dedicated LED Drive Cell for transmitting data from the Register to the dedicated LED or LED module.

With the architecture as described above, the current invention transmits a scan signal 510 by the Controller to the first LED Drive Cell 240-1 when an image frame starts. At the same time, the Controller also transmits the first bit of LED electric current or luminance data (LED data) to the Data Bus. The Counter within the DLDU counts and registers the LED data received from the data bus. The Controller, in accordance with the clocking, continues to transmit the next bit (2^{nd} bit, 3^{rd} bit, etc.) of LED data to the Data Bus sequentially. By receiving the subsequent LED data, the Counter continues to count by incrementing the number of count and to register the received subsequent LED data. With a predefined design requirement, an “M bits” of LED data is defined for the first Drive Cell. When the Counter identifies that the pre-defined “M bits” of LED data has been registered, the Counter transmits an “enable signal” to the Switch enabling and establishing the path to the first Drive Cell and sending the received “M bits” of LED data to the first Drive Cell.

At the time when the “M bits” 520 of LED data have been transmitted to the first Drive Cell 530, in accordance with the next continuous clocking, the Controller transmits a first bit of data for the second Drive Cell to the Data Bus 540. The Counter within the DLDU counts and registers the LED data for the second Drive Cell received from the Data Bus. The Controller, in accordance with the clocking, continues to transmit the next bit (2^{nd} bit, 3^{rd} bit, etc.) of LED data to the data bus sequentially for the second Drive Cell. By receiving the subsequent LED data for the second Drive Cell, the Counter continues to count by incrementing the number of count and register the received subsequent LED data for the second Drive Cell. With a predefined design requirement, an “N bits” of LED data is defined for the second Drive Cell. When the Counter identifies that the pre-defined “N bits” of LED data for the second Drive Cell have been registered, the Counter transmits an “enable signal” to the Switch enabling and opening the path to the second Drive Cell and sending the received “N bits” of LED data to the second Drive Cell.

With the same LED data delivery process as described above for the first and second Drive Cell, the Controller, Counter, Register, and the Switch continue to transmit LED data to the remaining Drive Cells within the first Driver IC. The FIG. 2 shows the first Driver IC has X Drive Cells. The same LED data delivery process would repeat until all data are delivered to the last Drive cell X.

When the data delivery completes for the first Driver IC, the same data delivery process as described above continues with the first Drive Cell within the second Driver IC until all data are delivered to the last Drive Cell within the second Driver IC.

The same LED data delivery process will continue to the next Driver IC (3^{rd} Driver IC, 4^{th} Driver IC, etc.) until the last Driver IC and concludes the end of LED data delivery for the first frame of the image data.

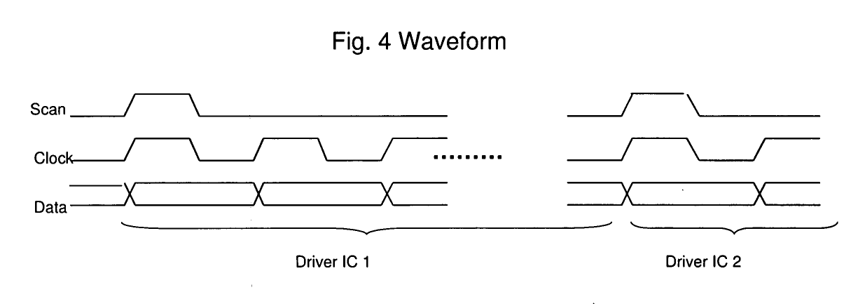

The FIG. 4 shows the relationship between the scan signal, clock signal, and the LED data signal. The scan signal is transmitted at the beginning of each image frame data for each Drive Cell. The clock signal continues regularly and drives the transmission of data signals bit by bit until the last Drive Cell of the first Driver IC.

With the signal delivery process as described above for each of the Drive Cells, the scan signals, clock signals, and data signals are latched for delivery. Each latched signal is on the basis of each Drive Cell. In other words, each Drive Cell illuminates its LED or LED module independent on receipt of other latch data that is designed for other Drive Cell.

1. A Light Emitting Diode (LED) lighting control system comprising:
at least one controller;
a plurality of driver ICs wherein each of the plurality of driver ICs comprises a pass gate and a DLDU and data bus; and
the driver ICs are sequentially connected by the data bus.

2. The Light Emitting Diode (LED) lighting control system of claim 1, wherein
each of the driver ICs comprises at least one drive cells; and
the drive cells are sequentially connected by way of transmitting LED data signals and control signals.

3. The Light Emitting Diode (LED) lighting control system of claim 2, wherein
all data signals for a drive cell are transmitted before data signals for another drive cell are transmitted, wherein the another drive cell is sequentially connected to the drive cell in sequence afterwards;
the data signals are transmitted by the pass gate to another driver IC not in accordance with clock signals.

4. The Light Emitting Diode (LED) lighting control system of claim 3, wherein
amount of data signals for each of the drive cells is a predefined quantity of data.

5. The Light Emitting Diode (LED) lighting control system of claim 4, wherein
the DLDU comprises a counter and a register and a switch module;
the counter counts quantity of data received for each of the drive cells;
the counter transmits an enable signal to the switch module when the predefined quantity of data has been received;
the enable signal enables establishing a transmission path in the switch module to a drive cell that the predefined quantity of data is designed for.

6. The Light Emitting Diode (LED) lighting control system of claim 1, wherein
the at least one controller generates control signals and data signals.

7. The Light Emitting Diode (LED) lighting control system of claim 6, wherein
the control signals include scan signals and clock signals;
the scan signals control data fetching by each LED driver cell from the data bus within the driver ICs; and
the clock signals provides timing clock to drive input of data signals.

8. A Light Emitting Diode (LED) lighting control system comprising:
at least one controller that generates control signals and data signals;
a plurality of driver ICs wherein each of the plurality of driver ICs comprises a pass gate and a DLDU and data bus; and
the driver ICs are sequentially connected by the data bus.

9. The Light Emitting Diode (LED) lighting control system of claim 8, wherein
each of the driver ICs comprises at least one drive cells;
the drive cells are sequentially connected by way of transmitting LED data signals and control signals;
the control signals include scan signals and clock signals;
the scan signals control data fetching by each LED driver cell from the data bus within the driver ICs; and
the clock signals provides timing clock to drive input of data signals.

10. The Light Emitting Diode (LED) lighting control system of claim 9, wherein
all data signals for a drive cell are transmitted before data signals for another drive cell are transmitted, wherein the another drive cell is sequentially connected to the drive cell in sequence afterwards;
the data signals are transmitted by the pass gate to another driver IC not in accordance with clock signals.

11. The Light Emitting Diode (LED) lighting control system of claim 10, wherein
amount of data signals for each of the drive cells is a predefined quantity of data.

12. The Light Emitting Diode (LED) lighting control system of claim 11, wherein
the DLDU comprises a counter and a register and a switch module;
the counter counts quantity of data received for each of the drive cells.

13. The Light Emitting Diode (LED) lighting control system of claim 12, wherein
the counter transmits an enable signal to the switch module when the predefined quantity of data has been received.

14. The Light Emitting Diode (LED) lighting control system of claim 13, wherein
the enable signal enables establishing a transmission path in the switch module to a drive cell that the predefined quantity of data is designed for.

15. A Light Emitting Diode (LED) lighting control system comprising:
at least one controller;
a plurality of driver ICs wherein each of the plurality of driver ICs comprises a pass gate and a DLDU and data bus; and
the driver ICs are sequentially connected by the data bus;
each of the driver ICs comprises at least one drive cells; and
the drive cells are sequentially connected by way of transmitting LED data signals and control signals.

16. A Light Emitting Diode (LED) lighting control system of claim 15, wherein
amount of data signals for each of the drive cells is a predefined quantity of data.

17. A Light Emitting Diode (LED) lighting control system of claim 16, wherein
all data signals for a drive cell are transmitted before data signals for another drive cell are transmitted, wherein the another drive cell is sequentially connected to the drive cell in sequence afterwards;
the data signals are transmitted by the pass gate to another driver IC not in accordance with clock signals.

18. A Light Emitting Diode (LED) lighting control system of claim 17, wherein
the DLDU comprises a counter and a register and a switch module;
the counter counts quantity of data received for each of the drive cells;
the counter transmits an enable signal to the switch module when the predefined quantity of data has been received;
the enable signal enables establishing a transmission path in the switch module to a drive cell that the predefined quantity of data is designed for.

19. A Light Emitting Diode (LED) lighting control system of claim 16, wherein
the at least one controller generates control signals and data signals.

20. A Light Emitting Diode (LED) lighting control system of claim 19, wherein
the control signals include scan signals and clock signals;
the scan signals control data fetching by each LED driver cell from the data bus within the driver ICs; and
the clock signals provides timing clock to drive input of data signals.
